(19) United States
(12) Patent Application Publication
(10) Pub. No.: US 2013/0208092 A1
(43) Pub. Date: Aug. 15, 2013

(54) SYSTEM FOR CREATING THREE-DIMENSIONAL REPRESENTATIONS FROM REAL MODELS HAVING SIMILAR AND PRE-DETERMINED CHARACTERISITICS

(71) Applicant: TOTAL IMMERSION, (US)

(72) Inventor: Renan Rollet, Bagnolet (FR)

(73) Assignee: TOTAL IMMERSION, Suresnes (FR)

(21) Appl. No.: 13/685,081

(22) Filed: Nov. 26, 2012

(30) Foreign Application Priority Data
Feb. 13, 2012 (FR) 1251338

(51) Int. Cl. H04N 13/02

(52) U.S. Cl. CPC H04N 13/0242; H04N 13/0203
USPC 348/46; 348/47

(57) ABSTRACT

A particular subject of the invention is the creation of three-dimensional representations from real models having similar and predetermined characteristics, using a system comprising a support suitable for receiving such a real object, configured to present the object in a pose similar to that of use of said at least one real object, an image acquisition device configured to obtain at least two distinct images of the real object from at least two separate viewpoints and a data processing device configured to receive these images, to clip a representation of the real object in each of these images in order to obtain at least two textures of the real object, obtaining a generic three-dimensional model of the real object and creating a three-dimensional model of the real object from the textures and the generic three-dimensional model obtained.

### CROSS-REFERENCE TO RELATED APPLICATIONS

This application claims the benefit of French Application No. 1251338, filed Feb. 13, 2012, the entire disclosures of which are incorporated herein by reference.

The present invention relates to the modelling of real objects and more particularly a system for creating three-dimensional representations from real models having similar and predetermined characteristics.

Three-dimensional representations of real objects are often used in computer systems for numerous applications such as computer-aided design or simulation. Thus, for example, three-dimensional representations of pairs of spectacles can be used by potential purchasers, in an augmented reality application, to help them to choose a specific pair of spectacles, in particular according to its shape and colour.

The three-dimensional representations are computer entities typically comprising a set of points and/or curves representing surfaces with which textures can be associated.

Such three-dimensional representations are usually generated from design software applications called CAD applications (acronym for Computer Aided Design).

They can also be created from real objects, for example by digitizing using a scanner which analyses these objects in order to obtain topological information and, if necessary, information relating to appearance such as colours and textures. Typically, a scanner determines the position of a sampling of points, in a predetermined system of coordinates, of the surfaces of the object to be modelled, in order to then extrapolate their shape.

Photographs of the objects can also be used in order to model them by image analysis.

However, whilst existing solutions make it possible to obtain good three-dimensional representations, they are generally complex to implement and/or have prohibitive costs. Therefore a need exists to improve them.

Thus a subject of the invention is a system for modelling a plurality of real objects having similar and predetermined characteristics, this system comprising the following devices,
a support capable of receiving at least one real object from said plurality of real objects having similar and predetermined characteristics, said support being configured to present the object in a position similar to that of use of said at least one real object;
at least one image acquisition device configured to obtain at least two distinct images of said at least one real object from at least two separate viewpoints;
a data processing device configured to implement the following steps,
receiving said at least two distinct images of said at least one real object;
clipping a representation of said at least one real object in each of said at least two images in order to obtain at least two textures of said at least one real object;
obtaining a generic three-dimensional model of said at least one real object; and
creating a three-dimensional model of said at least one real object from said at least two textures and said generic three-dimensional model obtained.

The system according to the invention, therefore makes it possible to facilitate the creation of three-dimensional representations of real objects having common and predetermined characteristics and reduce the costs of creating these three-dimensional representations.

According to a particular embodiment, the image acquisition device comprises at least one first and one second image sensors, said at least one first and one second image sensors being used to obtain each of said at least two images, respectively. Said at least one first and one second image sensors are, preferably, situated at positions that are fixed and predetermined with respect to said support.

The system according to the invention can thus be pre-calibrated and therefore allow the creation of three-dimensional representations of real objects having common and predetermined characteristics by people with no particular knowledge of modelling or of the field of the real objects in question.

According to a particular embodiment, said support has a uniform colour suitable for image processing of the chromakey type.

Still according to a particular embodiment, said support comprises at least one protrusion forming a resting point for said at least one real object and/or at least two openings forming two resting points for said at least one real object. The support therefore allows rapid and precise positioning of the real objects a three-dimensional representation of which must be obtained, thus facilitating the creation thereof.

Still according to a particular embodiment, said data processing device is moreover configured to identify a generic three-dimensional model from a plurality of generic three-dimensional models, said generic three-dimensional model obtained being said identified generic three-dimensional model, so as to improve the quality of said three-dimensional representation created.

Said data processing device can moreover be configured for retouching at least one of said at least two textures of said at least one real object in order to improve the quality of said three-dimensional representation created.

According to a particular embodiment, said data processing device is moreover configured for transmitting a command to said at least one image acquisition device, said at least two distinct images of said at least one real object being obtained in response to said command, in order to automate the process of creating three-dimensional representations. Said command can comprise a configuration parameter of said at least one image acquisition device in order to improve the control of the latter.

Other advantages, aims and features of the present invention will become apparent from the detailed description below, given by way of non-limitative example, with reference to the attached figures, in which:

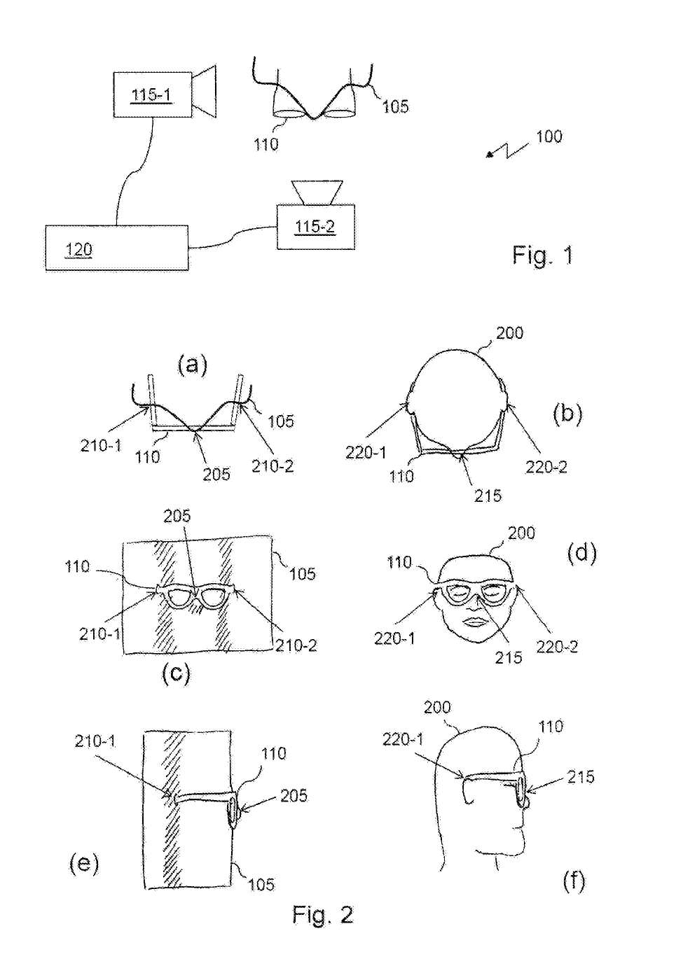

FIG. 1 illustrates an example of an environment making it possible to implement the invention for modelling real objects having common and predetermined characteristics;

FIG. 2, comprising FIGS. 2a to 2f, illustrates the way in which a real object to be modelled, in this case a pair of spectacles, is positioned on a support used for this purpose and in normal use conditions, i.e. in this case on a face, shown in top, front and side views;

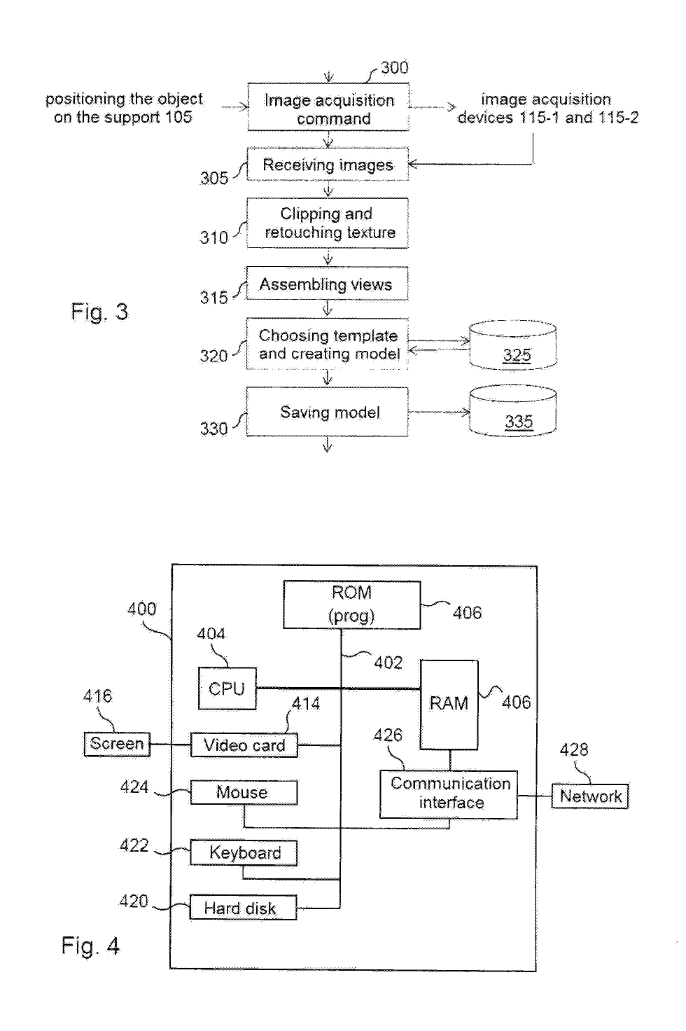

FIG. 3 illustrates diagrammatically certain steps implemented according to the invention for modelling a real object; and

FIG. 4 illustrates an example of a data processing device suitable for implementing the invention or part of the invention.

In general terms, a subject of the invention is automating the generation of three-dimensional representations of real objects having common and predetermined characteristics, such as pairs of spectacles. To this end, the invention utilizes a physical support for the real objects to be modelled, one or more image acquisition devices such as cameras and video cameras and a data processing device of the personal computer or work station type.

The physical support used for holding the real object to be modelled during modelling is suitable for holding the real object under conditions which are close to the conditions of use of this object. In particular, the physical support makes it possible to maintain the object in the position in which it is used, by masking the areas which are potentially masked during its use. Moreover, the support is arranged in such a way with respect to the image acquisition devices that it allows the use of a single standardized frame of reference for modelling several similar objects.

The support is advantageously produced from a material having a uniform colour and reflecting the light in a uniform way in order to facilitate the image processing, in particular the operations of extraction of image zones such as so-called chromakey operation.

It typically consists of a surface that is closed, for example a surface having a spherical or ovoid shape, or open, for example a surface generated by the development of a curve such as a plane curve having the shape of a curly bracket in a particular direction, i.e. extending the curve in this direction, as illustrated in FIGS. 1 and 2.

According to a particular embodiment, the support is produced from a translucent material and comprises a light source situated inside. This embodiment makes it possible to facilitate the extraction of the representation of the real object represented in an image according to a back lighting technique allowing in particular the extraction of textures of the object.

After an object to be modelled has been placed on the support, images of this object are obtained, for example an image from the front and an image from the side of the image. These images can be obtained from several fixed image acquisition devices and/or mobile image acquisition devices. These devices are connected to a data processing device of the personal computer type, making it possible to process and analyse the images obtained.

FIG. 1 illustrates an example of an environment 100 making it possible to implement the invention for modelling real objects having common and predetermined characteristics.

The environment 100 comprises in particular a support 105 configured for receiving at least one of the objects to be modelled, according to a particular position, in this case pairs of spectacles such as the pair of spectacles 110. According to the example given, the environment 100 comprises moreover two image acquisition devices 115-1 and 115-2; for example cameras, connected to a computer 120, for example a standard PC-type computer (acronym for Personal Computer).

The image acquisition devices 115-1 and 115-2 are in this case arranged with respect to the support 105 in such a way that the image acquisition device 115-1 is to one side with respect to a pair of spectacles to be modelled that is correctly placed on the support 105 and the image acquisition device 115-2 is in front of said pair of spectacles.

The computer 120 models the pair of spectacles 110 from the images acquired by the two image acquisition devices 115-1 and 115-2 as described with reference to FIG. 3.

It is observed that more than two image acquisition devices can be used or alternatively, a single image acquisition device can be used, by being moved, for the acquisition of several images of the object to be modelled.

The support 105 is for example produced front a plastic material such as PVC (polyvinyl chloride). As illustrated diagrammatically in FIGS. 1 and 2, the support 105 comprises two openings for receiving the ends of the spectacle side pieces and a protrusion suitable for receiving the two bridge supports fixed on the part of the frame situated between the lenses. The two openings and the protrusion are approximately aligned in a horizontal plane.

The two image acquisition devices 115-1 and 115-2 are situated at predetermined positions with respect to the support 105 so that the pose of the pair of spectacles 110, when it is positioned on the support 105, is constant and can be predetermined. In other words, the position of a pair of spectacles 110 on the support 105 is thus standardized due to the fact that the support has three reference resting points corresponding to the three natural points on which a pair of spectacles rests when worn (the ears and the nose). A single standardized frame of reference, associated with these three reference resting points, is therefore used for modelling all pairs of spectacles. This frame of reference is advantageously associated with a reference resting point, for example the resting point of the two bridge supports fixed on the part of the frame situated between the lenses, so that it can be easily used for the modelling, to make the link between the support used and a pair of spectacles as well as for positioning a model of a pair of spectacles on a representation of a face.

When a single image acquisition device is used, whilst being moved, it is displaced according to specific predetermined positions.

The support 105 is in this case such that it is possible, in a side-on camera shot to mask the rear of the opposite sidepiece and the part of the sidepieces hidden by the ears when the pair of spectacles is worn, and to separate the side pieces in such a way that they are no longer seen in a front view.

FIG. 2, comprising FIGS. 2a to 2f, illustrates the way in which the real object to be modelled, in this case a pair of spectacles, is positioned on a support used to this end and in normal use conditions, i.e. in this case on a face, seen from above, in top, front and side views.

Seen from above, FIGS. 2a and 2b show the way in which a pair of spectacles 110 is positioned on a support 105 and on a face 200, respectively. As shown, the pair of spectacles 110 lies on three resting points of the support 105, a resting point 205 associated with a protrusion of the support 105, having a role similar to that of a nose for maintaining the pair of spectacles 110 on a resting point 215, and two resting points 210-1 and 210-2, associated with openings formed in the support 105, in which are inserted the ends of the side pieces of the pair of spectacles 110 having a role similar to that of the ears for maintaining the pair of spectacles 110 on resting points referenced 220-1 and 220-2. The use of openings in the support 105 and not simple protrusions makes it possible to mask the end of the sidepieces (as do the ears). Of course, protrusions having a specific shape, such as that of ears, can be used as a resting point for the sidepieces and mask their end.

Similarly, FIGS. 2c and 2d show, in front view, the way in which the pair of spectacles 110 is positioned on the support 105 and on the face 200, respectively. Again, as shown, the pair of spectacles 110 rests on the three resting points 205, 210-1 and 210-2 of the support 105, having a role similar to the resting points 215, 220-1 and 220-2 of the face 200, associated with the nose and ears of the wearer of the pair of spectacles 110.

Also similarly, FIGS. 2e and 2f show, in side view, the way in which the pair of spectacles 110 is positioned on the support 105 and on the face 200, respectively. Again, as shown, the pair of spectacles 110 lies on the three resting points 205, 210-1 and 210-2 of the support 105 (the resting point 210-2 being in this case masked by the support 105), having a role similar to the resting points 215, 220-1 and 220-2 of the face 200 (the resting point 220-2 being in this case masked by the face 200), associated with the nose and ears of the wearer of the pair of spectacles 110.

According to the implementation illustrated in FIG. 1, two image acquisition devices 115-1 and 115-2 are arranged around the support 105, one making it possible to acquire images from the front and the other from one side of the support. Optionally a third image acquisition device of can be used to acquire images of the other side of the support. Similarly, a third or a fourth image acquisition device can optionally be used to acquire images from above (although that is of only limited interest for a pair of spectacles, such a view could prove useful for other real objects to be modelled). These devices are advantageously situated at an equal distance from the support if their optics is equivalent or at distances which take into account the optics used so that the representation of the real object to be modelled is on the same scale in each of the images acquired by these devices.

When two fixed image acquisition devices are used, it is possible to make the assumption that the real object to be modelled is symmetrical. In this case, regarding pairs of spectacles, it is assumed that the right-hand sidepiece is a reversed view of the left-hand sidepiece. Moreover, it is observed that such a hypothesis makes it possible to limit the volume of data stored in order to represent the real object.

As described previously, these image acquisition devices are connected to a computer, for example using a connection of USB type (acronym for Universal Serial Bus).

According to a particular embodiment, this connection is bidirectional. This allows each image acquisition device to be controlled, in particular for taking the shots and, if appropriate, to allow adjustments to be carried out such as control of the exposure time and of the ISO sensitivity of the photograph. It also allows the transfer of the acquired images to a mass memory, for example a hard disk, of the computer to which the image acquisition devices are connected.

FIG. 3 illustrates diagrammatically certain steps implemented according to the invention for modelling a real object.

After the real object to be modelled, in this case a pair of spectacles, has been positioned on the support provided for this purpose, in a predetermined position, a command is sent by the computer connected to the image acquisition devices used to implement the invention (step 300). This command can comprise a simple instruction for the acquisition of an image or a more complex command intended for configuring the image acquisition device(s) according to specific parameters. Alternatively, the command is intended to save images streamed to the computer.

This command can be generated manually, by a user, or automatically by the detection of the presence of the real object to be modelled on the support provided for this purpose. Such detection can be carried out by image analysis or by using contacts.

The images acquired are received by the computer in a step referenced 305.

A clipping operation is then carried out on the images received in order to extract from them the contour of the representation of the real object to be modelled (step 310). The resulting textures, obtained according to the contours determined, can be retouched in order to remove possible artifacts.

The clipping step can in particular be carried out using an algorithm of chromakey type which aims to remove a set of points having a predetermined colour, typically green, according to a given threshold. This algorithm is in this case particularly suitable for modelling prescription spectacles the lenses of which are transparent. This algorithm can be completed by an analysis of an image similar to that previously used, taken under backlighting conditions, in order to estimate the transparency of the object, i.e. a characteristic of the texture, in this case of the lenses. Such an additional step is particularly suitable for the modelling of pairs of sun glasses.

This clipping step, completed if appropriate by the step(s) described previously, allows a representation to be obtained, in two dimensions, of at least two parts of the pair of spectacles to be modelled (using the two images, one taken from the front and the other from the side). These two parts correspond to the front view and to the side view.

These representations (or views) are then in this case combined (step 315) in order to create a planar representation of the pair of spectacles.

As described previously, if only two images are used (one representing a front view and the other a side view), the representation of the pair of spectacles from the side, i.e. the representation of a side piece, is duplicated symmetrically in a vertical plane positioned between the side piece and the part of the frame comprising the lenses in order to create a representation of the missing sidepiece.

In a following step (step 320), a template, i.e. a three-dimensional model, typically generic and without texture, is sought in a database 325 comprising a plurality of templates having varied shapes and/or sizes. The chosen template is the template the shape and size of which are the closest to the representation of the pair of spectacles determined during the previous steps. In other words, the chosen template is that minimizing the surface not covered by the representation of the pair of spectacles when the latter is applied to the template. Alternatively, a single generic template can be used.

The three-dimensional model of the pair of spectacles is then created by in this case using a known so-called impostor technique consisting of applying a texture onto a predetermined three-dimensional model.

The three-dimensional model obtained is then stored (step 330) in a database 335. This three-dimensional model obtained is a simplified model of the pair of spectacles placed on the support 105, based on a simplified geometry typically comprising 3 to 6 surfaces.

Therefore, in other words, the simplified three-dimensional model is based on a generic model of spectacles (shape template) chosen, if necessary, from several, and on a cut-out texture having, according to a particular embodiment, an alpha channel for the intermediate transparency values.

It is observed in this case that if, for the clipping step, the lighting and the shot parameters such as the exposure time, the white balance and the sensitivity are not modified in the modelling from one pair of spectacles to another, the clipping parameters, for example the parameters of the algorithm of chromakey type used, remain the same. The system is then adjusted for colour.

Moreover, if the system is correctly calibrated, in particular if the distances between the image acquisition devices and the pair of spectacles are the same (or compensated by the optics used), if there are always the same three resting points of the support which are used and if the same template is used, the creation of a three-dimensional model can be fully automated for a whole set of pairs of spectacles. In fact, by saving the parameters associated with the modelling of a first pair of spectacles, in particular the parameters of positioning and scale, it is possible to use them for subsequent modellings of pairs of spectacles. The system is then adjusted for positioning.

It is noted here that although several templates can be used if they have similar profiles, (for example as regards the position of the joints of the pairs of spectacles), in practice the templates often have different widths which could lead to misalignment in positioning and/or scale.

FIG. 4 illustrates an example of a data processing device which can be used to implement the invention at least partially, in particular the steps described with reference to FIG. 3. The device 400 is for example a computer of PC type.

The device 400 preferably comprises communication bus 402 to which are connected:
a Central Processing Unit (CPU) or microprocessor 404;
a Read Only Memory (ROM,) 406 which can contain the operating system and programs such as “Prog”; and
a Random Access Memory (RAM) or cache memory 408 containing registers capable of saving the variables and parameters created and modified during the execution of the above-mentioned programs.

Optionally, the device 400 can also have the following elements:
a communication interface 426 connected to a communication network 428, for example the Internet, the interface being capable of sending and receiving data;
a graphics card 414 connected to a screen 416;
a hard disk 420 which can comprise the above-mentioned programs “Prog” and the data processed or to be processed according to the invention;
a keyboard 422 and a mouse 424 or any other pointing device such as a light pen, a touch screen or a remote control making it possible for the user to interact with the programs according to the invention; and
a memory card reader (not shown) capable of reading from it or writing to it the data processed or to be processed according to the invention.

The communication bus allows communication and interoperability between the different elements included in the device 400 or linked thereto. The representation of the bus is not limitative and, in particular, the central processing unit is capable of communicating instructions to any element of the device 400 directly or via another element of the device 400.

The executable code of each program allowing the programmable device to implement the procedures according to the invention can be stored, for example, on the hard disk 420 or in read only memory 406.

According to a variant, the executable code of the programs can be received using the communication network 428, via the interface 426, for storage in a way identical to that described previously.

More generally, the program(s) can be loaded into one of the storage means of the device 400 before being executed.

The central processing unit 404 will control and direct the execution of the instructions or portions of software code of the program or programs according to the invention, instructions which are stored on the hard disk 420 or in the read only memory 406 or in the other above-mentioned storage elements. When powered up, the program or programs which are stored in a non-volatile memory, for example the hard disk 420 or the read only memory 406, are transferred to the random access memory 408 which then contains the executable code of the program(s) according to the invention, as well as the registers for storing the variables and parameters necessary for the implementation of the invention.

It should be noted that the communication device containing the device according to the invention can also be a programmed device. This device then contains the code of the software program(s) for example fixed in an application specific integrated circuit (ASIC).

Of course, to satisfy specific requirements, a person skilled in the field of the invention can apply modifications to the preceding description. In particular, although the invention has been particularly described in the context of modelling pairs of spectacles, it can be implemented for any other real object having common and predetermined characteristics.

What is claimed is:

1. A system for modeling one or more real objects, comprising:
a support system capable of receiving and positioning one or more real objects in a particular pose;
at least one image acquisition device configured to obtain at least two distinct images of the real object on the support system from at least two separate viewpoints; and
a processor in communication with the at least one image acquisition device, wherein the processor executed a program code stored in a memory to:
receive said at least two distinct images of said at least one real object;
clip a representation of the real object from the at least two images to obtain at least two textures of the real object;
obtain a generic three-dimensional model of the real object; and
create a three-dimensional model of the real object from the at least two textures and the generic three-dimensional model.

2. The system according to claim 1, wherein the at least one image acquisition device further comprises a first image sensor and a second image sensor, said at least one first and one second image sensors being used to obtain each of said at least two images, respectively.

3. The system according to claim 2, wherein the first and second image sensors are fixed at predetermined positions with respect to the support system.

4. The system according to claim 1, wherein the support system has a uniform color suitable for the processing of images of the chromakey type.

5. The system according to claim 1, wherein the support system further comprises at least one protrusion forming a resting point for the one or more real objects.

6. The system according to claim 1, wherein the support system further comprises at least two openings forming two resting points for the one or more real objects.

7. The system according to claim 1, wherein the program code executed by the processor is configured to identify a generic three-dimensional model from a plurality of generic three-dimensional models, wherein the generic three-dimensional model obtained is the identified generic three-dimensional model.

8. The system according to claim 1, wherein the program code executed by the processor is configured for retouching at least one of said at least two textures of the one or more real objects.

9. The system according to claim 1, wherein the program code executed by the processor is configured to transmit a command to said at least one image acquisition device to obtain said at least two distinct images of said at least one real object.

10. The system according to claim 9, wherein the command comprises a configuration parameter for the at least one image acquisition device.
